(19) United States
(12) Patent Application Publication
(10) Pub. No.: US 2012/0162397 A1
(43) Pub. Date: Jun. 28, 2012

(54) IMAGE PROCESSING APPARATUS AND DISPLAY CONTROLLING METHOD

(75) Inventor: Yoshikazu Terunuma, Tokyo (JP)

(73) Assignee: KABUSHIKI KAISHA TOSHIBA, Tokyo (JP)

(21) Appl. No.: 13/337,912

(22) Filed: Dec. 27, 2011

(30) Foreign Application Priority Data
Dec. 28, 2010 (JP) P2010-294063

(51) Int. Cl. H04N 13/04

(52) U.S. Cl. 348/51; 348/E13.075

(57) ABSTRACT

According to one embodiment, an image processing apparatus includes a receiver and an output module. The receiver configured to receive a video data and audio data corresponding to the video data, the video data comprising a character image. The output module configured to output a first and a second image to a display, where a parallax of the first and the second images depends on the volume level of the audio data, the first image and the second image being based on the character image.

### CROSS-REFERENCE TO RELATED APPLICATIONS

This application is based upon and claims the benefit of priority from Japanese Patent Application No. P2010-294063, filed Dec. 28, 2010; the entire contents of which are incorporated herein by reference.

### FIELD

Embodiments described herein relate generally to an image processing apparatus and display controlling method.

### BACKGROUND

There is provided a technique for causing the user to perceive three-dimensional (3D) video image by displaying left-eye-image and right-eye-image which have mutual parallaxes. In this technique, barriers or lenses covering the display screen or glasses worn by the user selectively blocks the left-eye-image or right-eye-image displayed on the display screen. The user views the left-eye-image by left eye and views the right-eye-image by right eye, and cognize 3D video.

In case of displaying video content, dialogue images or narration images are displayed in an area predetermined for dialogue, and character images concerning sound effects are displayed in an area predetermined for main video. In this case, displaying these character images in preferred form is desirable.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary conceptual diagram illustrating the utility form of an image processing apparatus according to an embodiment.

FIG. 2 is an exemplary block diagram illustrating the system configuration of the image processing apparatus of the embodiment.

FIG. 3 is an exemplary block diagram illustrating the functional configuration of a video reproduction program of the embodiment.

FIG. 4 is an exemplary conceptual diagram illustrating an example of a process determining volume level which is executed by the image processing apparatus of the embodiment.

FIG. 5 is an exemplary conceptual diagram illustrating an example of a process converting images of character which is executed by the image processing apparatus of the embodiment.

FIG. 6 is an exemplary flowchart illustrating example of the procedure of the process converting images of character which is executed by the image processing apparatus of the embodiment.

### DETAILED DESCRIPTION

Various embodiments will be described hereinafter with reference to the accompanying drawings.

In general, according to one embodiment, an image processing apparatus includes a receiver and an output module. The receiver configured to receive a video data and an audio data corresponding to the video data, the video data comprising a character image. The output module configured to output a first and a second image to a display, where a parallax of the first and the second images depends on the volume level of the audio data, the first image and the second image being based on the character image.

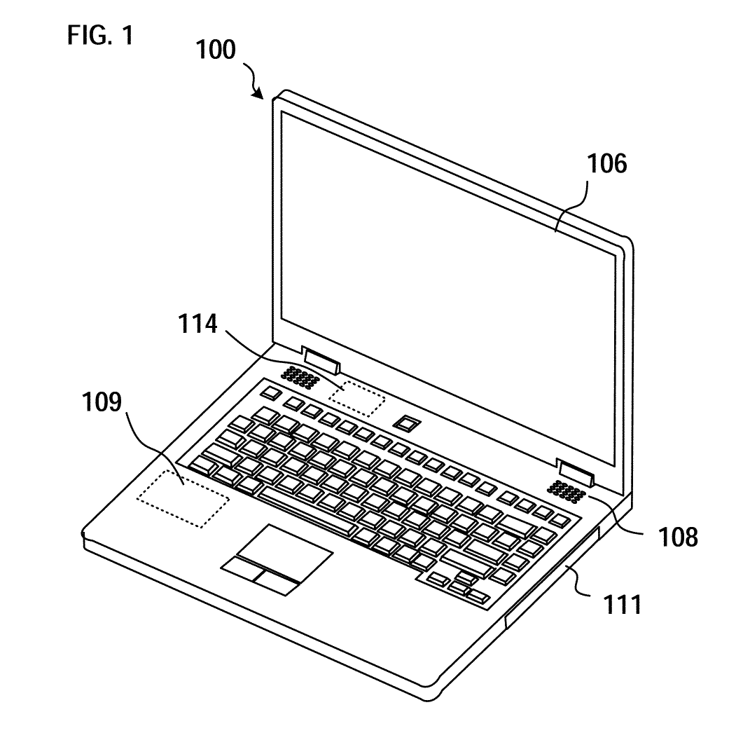

FIG. 1 illustrates an example of a utility form of an image processing apparatus according to an embodiment. The image processing apparatus is realized, for example, as a notebook-type personal computer 100. As shown in FIG. 1, the computer 100 includes a display body 150 and a computer main body 160.

The display body 150 is thin-box shape and includes

LCD (Liquid Crystal Display) 106. The display body 150 is rotatably connected to the computer main body 160.

The computer 100 according to the embodiment can control the depth position at which three-dimensional (3D) images of character displayed, and/or can control size (resolution) of the 3D images of character.

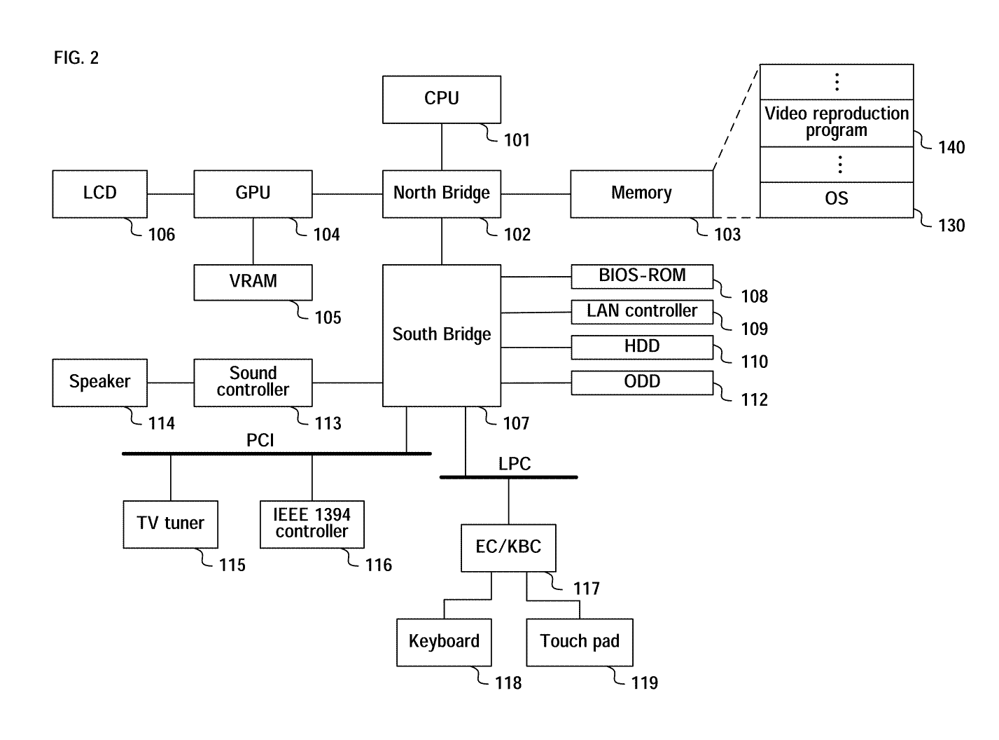

FIG. 2 shows the example of a system configuration of the computer 100.

The computer 100, as shown in FIG. 2, includes a CPU 101, a north bridge 102, a memory 103, a GPU 104, a video memory (VRAM) 105, LCD 106, a south bridge 107, a BIOS-ROM 108, a LAN controller 109, a hard disk drive (HDD) 110, an optical disc drive (ODD) 112, a sound controller 113, a speaker 114, a TV tuner 115, an IEEE1394 controller 116, an embedded controller/keyboard controller (EC/KBC) 117, a keyboard (KB) 118, and a touch pad 119.

The CPU 101 is a processor for controlling the operations of the respective components in the computer 100. The CPU 101 executes an operating system (OS) 130 and application programs, such as a video reproduction program 140, which are loaded from the HDD 110 into the memory 103.

The north bridge 102 is a bridge device which connects the CPU 101 and the south bridge 107. The north bridge 102 includes a memory controller which access-controls the memory 103. The north bridge 102 also has a function of communicating with the GPU 104, and cause the GPU 104 to execute an image processing in accordance with a command from the CPU 101.

The GPU 104 is a device which controls the LCD 106 that is used as a display of the computer 100. The GPU 104 converts video data input from the CPU 101 to generate display signal, and send the display signal to the LCD 106. The LCD 106 displays video based on the display signal.

The south bridge 107 controls devices on a peripheral component interconnect (PCI) bus and devices on a low pin count (LPC) bus. The BIOS-ROM 108, the LAN controller 109, the HDD 110, and ODD 112 are connected to the south bridge 107. The south bridge 107 includes an integrated drive electronics (IDE) controller for controlling the HDD 110 and the ODD 112. The south bridge 107 also has a function of communicating with the sound controller 113.

The BIOS-ROM 108 stores BIOS (Basic Input/Output System) for controlling hardware in the computer 100.

The LAN controller 109 controls communication between the computer 100 and a LAN network. The LAN controller 109 also connects the computer 100 with an internet via the LAN network, and receives video data of IP television via the LAN network.

The HDD 110 is a storage device which stores various programs such as an OS 130 and a video reproduction program 140. The HDD 110 is used as storing area to store video and audio data of television received by the TV tuner 115 when video recording process is executed.

The ODD 112 reads/writes data, e.g. video data, to optical disc.

The sound controller 113 is a sound source device and outputs audio data, which is a target of reproduction, to the speaker 114. The speaker 114 outputs sound based on the audio data.

The TV tuner 115 and the IEEE 1394 controller 116 are connected to the south bridge 107 via the PCI bus. The TV tuner 115 receives video data and audio data superimposed in a television broadcast signal. The TV tuner 115 receives video data for 2D display or 3D display (2D video data or 3D video data, respectively). The video data for 3D display means video data including parallax images such as left-eye image and right-eye image. The IEEE 1394 controller 116 execute communication to external device via serial bus based on IEEE 1394 standard.

The EC/KBC 117 is connected to the south bridge 107 via the LPC bus. The EC/KBC 117 controls the keyboard 118 and the touch pad 119. The keyboard 118 and the touch pad 119 receive input of various operations from user. The EC/KBC 117 outputs the operation signal to the CPU 101.

For the display of 3D video, the computer 100 may use, for example, a shutter method (also referred to as “time-division method”). In the shutter method, left-eye image and right-eye image are alternately displayed on the LCD 106. The LCD 106 is driven by a refresh rate (e.g. 120 Hz) which is twice the normal refresh rate (e.g. 60 Hz). In other words, the left-eye frame data in the left-eye video data and the right-eye frame data in the right-eye video data are alternately displayed on the LCD 106 with a refresh rate of, e.g. 120 Hz.

The user can view the image corresponding to the left-eye frame by the left eye and the image corresponding to the right-eye frame by the right eye, for example by using 3D glasses (not shown) such as liquid crystal shutter glasses. The 3D glasses may be configured to receive a synchronization signal, which indicates a display timing of the left-eye frame data and right-eye frame data, from the computer 100 by using, e.g. infrared. The left-eye shutter and right-eye shutter in the 3D glasses are opened/closed in synchronization with the display timing of the left-eye frame data and right-eye frame data on the LCD 106.

Alternatively, for the display of 3D video, use may be made of a polarization method. In this case, for example, interleaved frames, in which a left-eye image and a right-eye image are interleaved in units of a scanning line, are generated, and the interleaved frames are displayed on the LCD 106. A polarizing filter covering the screen of the LCD 106 polarizes the left-eye image, which is displayed, for example, in odd-numbered lines on the screen of the LCD 106, and the right-eye image, which is displayed in even-numbered lines on the screen of the LCD 106, in different directions. By using polarizing glasses, the user sees the left-eye image only by the left eye and sees the right-eye image only by the right eye.

Alternatively, the computer 100 may display 3D video according to a barrier method or a lens method (glasses-free method). In these methods, barriers or lenses covering the LCD 106 selectively block one of the parallax images (e.g. left-eye image and right-eye image). In other words, barriers or lenses covering the LCD 106 selectively transmit one parallax image of plurality of images having parallax each other. By using these methods, the user views 3D video.

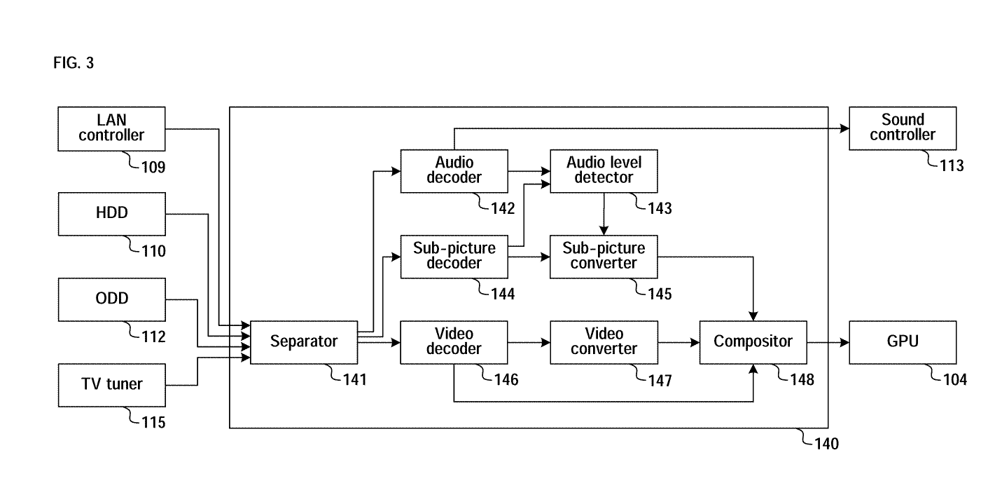

FIG. 3 shows an exemplary block diagram illustrating the functional configuration of the video reproduction program 140. The video reproduction program 140 includes a separator 141, an audio decoder 142, an audio level detector 143, a sub-picture decoder 144, a sub-picture converter 145, a video decoder 146, a video converter 147 and a compositor 148.

The separator 141 receives data of video content for 2D display (2D video data) or data of video content for 3D display (3D video data), from the LAN controller 109, the HDD 110, the ODD 112, and the TV tuner 115. The separator 141 separates audio data, sub-picture data (e.g. dialogue data), and video data (e.g. main image data), these data included in the received data. The separator 141 outputs audio data to the audio decoder 142, sub-picture data to the sub-picture decoder 144, video data to the video decoder 146.

The audio decoder 142 decodes audio data input from the separator 141, and outputs the decoded audio data to the audio level detector 143 and the sound controller 113.

The audio level detector 143 detects (determines) volume level of the audio data input from the audio decoder 142. The audio level detector 143 outputs volume information associated with the detected (determined) volume level of the input audio data to the sub-picture converter 145. The audio level detector 143 detects volume level in, for example, a section (scene) in which one pieces of dialogue image (sub-picture) is displayed. The audio level detector 143 determines the section based on a dialogue time information input from the sub-picture decoder 144.

The sub-picture decoder 144 decodes sub-picture data input from the separator 141, and outputs the decoded sub-picture data to the sub-picture converter 145. The sub-picture decoder 144 determines, based on a presentation time stamp (PTS) included in the sub-picture data input from the separator 141, a section in which one pieces of dialogue image (one piece of sub-picture) is displayed in the video content. The sub-picture decoder 144 outputs the dialogue time information associated with the time of the determined section to the audio level detector 143.

The sub-picture converter 145 converts the sub-picture data input from the sub-picture decoder 144 to generate sub-picture data for 3D display (3D sub-picture data). The sub-picture converter 145 generates the 3D sub-picture data so that image of the 3D sub-picture displayed at the depth position according to the volume level indicated by the volume information input from the audio level detector 143. In other words, the sub-picture converter 145 generates the 3D sub-picture so that, for example, a stereo image corresponding to the 3D sub-picture being displayed at the nearer depth position to the viewer (user) when the volume level indicated by the volume information is higher than a predetermined threshold level. The sub-picture converter 145 outputs the generated right-eye sub-picture and left-eye sub-picture (parallax sub-picture) to the compositor 148.

The video decoder 146 decodes the video data input from the separator 141. The video decoder 146 receives the video data for 2D (2D video data) or the video data for 3D display (3D video data). The video decoder 146 outputs the decoded video data to the video converter 147 when the input video data is 2D video data. The video decoder 146 outputs the decoded video data to the compositor 148 when the input video data is 3D video data.

The video converter 147 generates the video data for 3D display (3D video data) by using the decoded video data for 2D display (2D video data) . The video converter 147 analyzes each of the image frames of the decoded video data, and estimates depths (depth positions) of pixels included in image frames in the video data by using, for example, motion vectors of pixels inter frames and difference of values of pixels in one frame. The video converter 147 converts the input video data to 3D video data using the estimated depths of pixels. The 3D video data includes, for example, first left-eye image data and first right-eye image data with a parallax based on the depths of pixels in the image frame. The video converter 147 outputs the 3D video data to the compositor 148.

The compositor 148 composites the sub-picture from the sub-picture decoder 144, and the video data from the video decoder 146 or from the video converter 147. The compositor 148 outputs the composite data to the GPU 104.

Alternatively, the video converter 147 may output the video data to the compositor 148 unless converting 2D video data to 3D video data. Thus, the computer 100 may display 2D main image (2D video image) when displaying 3D dialogue image (3D sub-picture image).

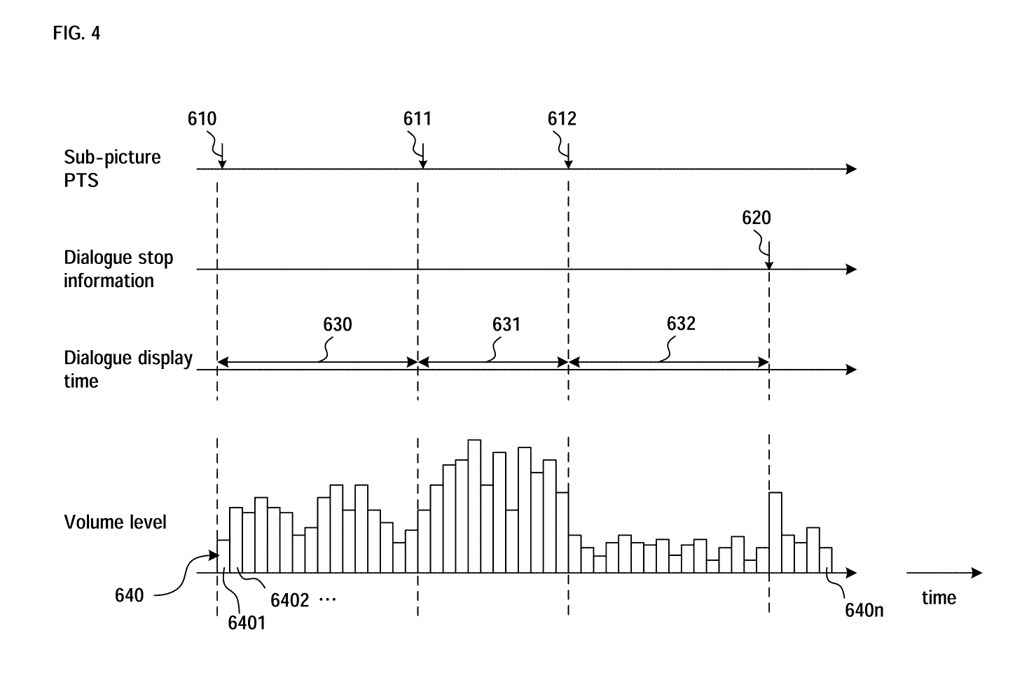

A conceptual diagram shown in FIG. 4 illustrates an example of a process determining volume level which is executed by the audio level detector 143.

The audio level detector 143 detects (determines) volume level based on the audio data from the audio decoder 142 and the dialogue time information from the sub-picture decoder 144.

The sub-picture decoder 144 decodes the stream of sub-picture data, and extracts a PTS (Presentation Time Stamp), dialogue stop information, and dialogue position information included in the stream of sub-picture data. The PTS indicates start time of the sub-picture. The dialogue stop information indicates stop time of the sub-picture. The dialogue position information indicates the display position (coordinate) of the sub-picture. The sub-picture decoder 144 outputs the dialogue time information (e.g. the PTS and/or the dialogue stop information) associated with display time of the dialogue image.

For example, assume that the PTS of sub-pictures indicate time 610, time 611, and time 612, and the dialogue stop information indicates time 620. Then, each dialogue images is displayed in section 630 from time 610 to time 611, section 631 from time 611 to time 612, and section 632 from time 612 to time 620.

The level gauge 640 indicates transition of volume level of audio sample 6401-640n. The audio level detector 143 detects, for example, average volume level of respective section corresponding to dialogue display time in which one dialogue image is displayed. The audio level detector 143 outputs, to the sub-picture converter 145, audio level information associated with the detected volume level, and time information indicating section in which the volume level is detected. Thus, the audio level detector 143 calculates, with respect to each section in which each sub-picture is displayed, volume level of the section corresponding to the section in which each sub-picture of dialogue image is displayed, and outputs the detected volume level to the sub-picture converter 145. The sub-picture converter 145 converts 2D image of character (2D character image) included in 2D sub-picture to 3D image of character (3D character image) such that the 3D image of character displayed at depth being different according to respective sub-pictures.

Alternatively, the audio level detector 143 does not necessarily detects the average volume level in section, leastwise detects information associated with volume level. In other words, the audio level detector 143 may detect, for example, maximum volume level in section. The audio level detector 143 may extract voice component in audio data, and may detect volume level of the extracted component.

The audio level detector 143 may calculate (detect) volume level of respective sections each corresponding to each of sub-pictures. Alternatively, the audio level detector 143 may divide one section corresponding to one sub-picture into plural sections having a certain span, and may detect volume level of each of the plural sections. Then, the audio level detector 143 outputs, to the sub-picture converter 145, the detected volume level and time information concerned with time section of which the volume level is detected.

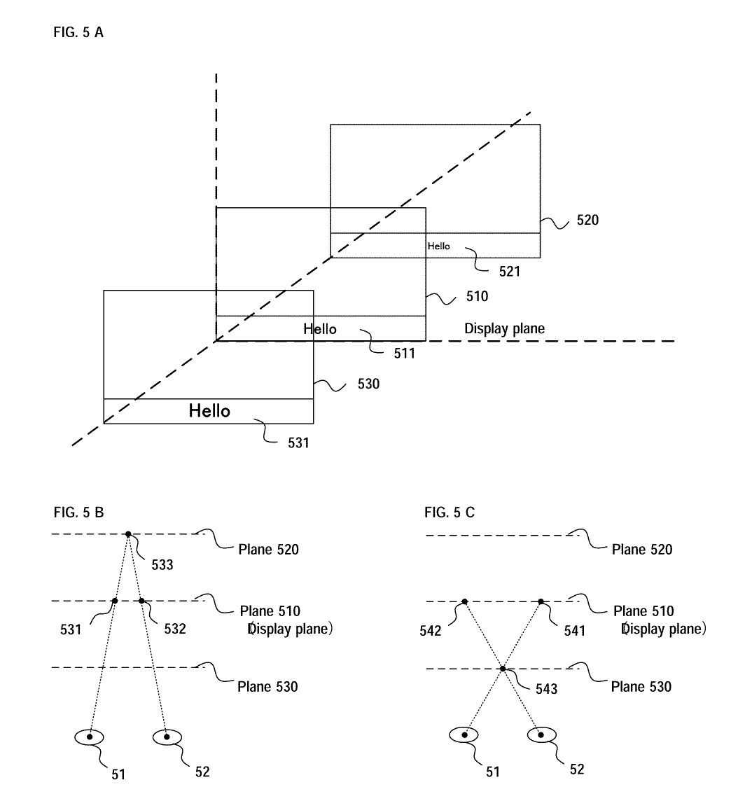

FIG. 5 A illustrates an example of depth position of 3D character image generated by the sub-picture converter 145.

The sub-picture converter 145 converts 2D sub-picture corresponding to the section (time) indicated by the time information to generate 3D sub-picture whose depth position is corresponding to the volume level information corresponding to the section, when the volume level information and time information corresponding to the volume level information are input from audio level detector 143 to the sub-picture converter 145.

Thus, for example, the sub-picture converter 145 converts the input sub-picture (2D character image) to generate 3D character image 521 so that the character image 521 is displayed at plane 520 positioning back of a display plane 510 of the LCD 106 (deeper than the display plane 510), when the input volume level information indicates smaller value than the predetermined threshold Th1.

The sub-picture converter 145 converts the input sub-picture (2D character image) to generate 3D character image 531 so that, for example, the character image 521 is displayed at plane 530 positioning in front of the display plane 510 (shallower than the display plane 510) , when the input volume level information indicates smaller value than the predetermined threshold Th2. The sub-picture converter 145 converts the input sub-picture (2D character image) to generate 3D character image 511 so that, for example, the character image 511 displayed at the display plane 510, when the input volume level information indicates value between the threshold Th1 and threshold Th2.

The sub-picture converter 145 may convert a character image included in one piece of sub-picture to generate 3D character image whose size (resolution) is corresponding to the depth position at which the 3D character image is displayed. Thus, the sub-picture converter 145 generates the 3D character image of small size when the 3D character image is displayed at back (deep) position, and generates the 3D character image of large size when the 3D character image is displayed at front (shallow) position.

FIG. 5 B and FIG. 5 C illustrate an example of a relation between the planer position of right-eye image and left-eye image obtained by the 3D conversion and the depth position perceived by the user when the right-eye image and the left-eye image are displayed at LCD 106.

Left-eye 51 and right-eye 52 of the user view 3D image positioning at position 533 on the plane 520, when left-eye image 531 and right-eye image 532 are displayed on the display surface plane with certain parallax as illustrated in FIG. 5 B. Thus, the computer 100 can display 3D image at the back of the display plane 510 (deeper plane than the display plane 510), by converting 2D image to generate and display the left-eye image and right-eye image, such that the left-eye image positions left position of the right-eye image and parallax between left-eye and right-eye image is smaller than the distance of left-eye 51 and right-eye 52. In the case as illustrated in FIG. 5B, the bigger the parallax between left-eye and right-eye image, the deeper the depth position becomes.

Left-eye 51 and right-eye 52 of the user view 3D image positioning at position 543 on the plane 530, when left-eye image 541 and right-eye image 542 are displayed on the display surface plane with certain parallax as illustrated in FIG. 5 C. Thus, the computer 100 can display 3D image at the front of the display plane 510 (shallower plane than the display plane 510), by converting 2D image to generate and display the left-eye image and right-eye image, such that the left-eye image positions right position of the right-eye image. In the case as illustrated in FIG. 5 C, the bigger the parallax between left-eye and right-eye image, the shallower the depth position becomes.

Thus, the sub-picture converter 145 converts, when volume level information and time information corresponding to the volume level information is input from the audio level detector 143, character image included in the sub-picture corresponding to the time indicated by the time information to generate left-eye image and right-eye image having parallax corresponding to the volume level information.

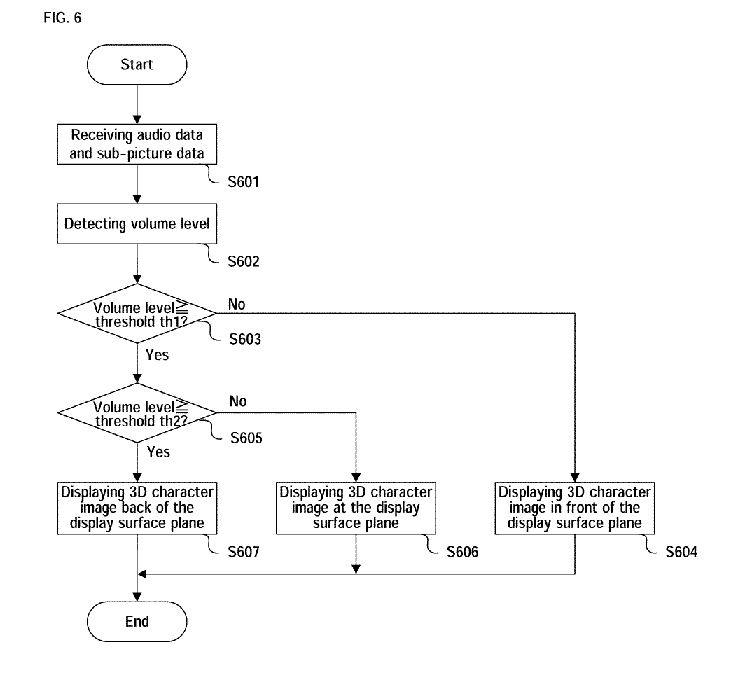

FIG. 6 illustrates an example of the procedure of the process converting 2D character image to 3D character image.

The video reproduction program 140 receives data including audio data and sub-picture data (S601). The video reproduction program 140 detects the level of input audio data (S602) . The video reproduction program 140 determines whether the detected volume level higher than the threshold TH1 (S603). When the detected level is lower than the TH1 (No, in S603), the video reproduction program 140 converts the character image included in the sub-picture to generate 3D character image such that the 3D character image is displayed at plane 520, the plane 520 positioning back position of the display plane. The LCD 106 displays the 3D character image (S604).

When the detected level is higher than the TH1 (Yes, in S603), the video reproduction program 140 determines whether the detected volume level is higher than the threshold Th2 (S605). When the detected level is lower than the TH2 (No, in S605), the video reproduction program 140 does not generate 3D character image and outputs 2D character image to the LCD 106. The LCD 106 displays the 2D character image on the display plane (S606).

When the detected level is higher than the TH2 (Yes, in S605), the video reproduction program 140 converts the character image included in the sub-picture to generate 3D character image such that the 3D character image is displayed at plane 530, the plane 530 positioning front position of the display plane. The LCD 106 displays the generated 3D character image (S607).

The description for above process flowchart describes the character image is displayed at one of the plane 520, the display plane 510 and the plane 530, however, the depth position at which the character image is displayed is not limited in the above description. Depth position of character image at least varies depending on volume level. Thus, for example, character image maybe displayed at one of the plural depth position, based on the volume level. The video reproduction program 140 may generate 3D character image corresponding to one sub-picture such that the 3D character image being displayed at smoothly varying depth position depend on the change of volume level in section corresponding to the one sub-picture.

The video reproduction program 140 may control depth position of 3D character image when input character image, e.g. dialogue image and ticker image, to the program 140 is embedded in main picture data (video data). In this case, the video converter extracts the character image in main picture and generates 3D character image whose depth position depending on the volume level.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a receiver configured to receive video data and audio data corresponding to the video data, the video data comprising a character image; and
an output module configured to output a first and a second image to a display, wherein a parallax of the first and second images is based on a volume level of the audio data, the first image and the second image being based on the character image.

2. The image processing apparatus of claim 1, wherein the parallax of the first and second images is based on a volume level of a section in the audio data, the section corresponding to the character image.

3. The image processing apparatus of claim 1, wherein a size of the first and second images is based on the volume level.

4. The image processing apparatus of claim 1, wherein the parallax of the first and second images is based on a volume level of a voice component in the audio data.

5. The image processing apparatus of claim 2, wherein the receiver is further configured to receive a plurality of character images, and the output module is further configured to output a plurality of first and second image pairs, each pair respectively based on a character image of the plurality of character images, wherein a parallax of each of the plurality of first and second image pairs differs.

6. The image processing apparatus of claim 2, wherein the receiver is further configured to receive the video data comprising one character image, and the output module is further configured to output the first and second image.

7. The image processing apparatus of claim 6, wherein the parallax of the first and second images is based on a volume level in one or more section in the audio data corresponding to the one character image, one or more section having constant length.

8. The image processing apparatus of claim 1, further comprising the display configured to display the first and second image.

9. An image processing apparatus comprising:
a receiver configured to receive video data and audio data corresponding to the video data, the video data comprising a character image; and
an display controller configured to cause a display to display 3D image, wherein a depth position of the 3D image is based on a volume level of the audio data, the 3D image corresponding to the character image.

10. An display controlling method comprising:
receiving video data and audio data corresponding to the video data, the video data comprising a character image; and
outputting a first and a second image to the display, wherein a parallax of the first and second images is based on a volume level of the audio data, the first image and the second image being based on the character image.
